(19) United States
(12) Patent Application Publication
(10) Pub. No.: US 2010/0109828 A1
(43) Pub. Date: May 6, 2010

(54) Transformer

(75) Inventors: Chih-Ping LU, Zhubei City (TW); Chih-Shen Chiang, Zhubei City (TW)

Correspondence Address: HDLS IPR Services, PO Box 220746, Chantilly, VA, 20153, US

(73) Assignee: Logah Technology Corp.

(21) Appl. No.: 12/609,030

(22) Filed: Oct. 30, 2009

(30) Foreign Application Priority Data
Nov. 3, 2008 (TW) 097219588

(51) Int. Cl. H01F 27/30; H01F 27/29

(52) U.S. Cl. 336/192

(57) ABSTRACT

A transformer includes a main body and a wire. The main body has several winding partitions and two end portions. Several leads are disposed in either end portion and a buffer region is formed between the right end portion and the right-most winding partition. An intermediate area is disposed between the buffer region and the right-most winding partition. One end of the wire is connected to one of the leads and the wire passes the right end portion. Before the wire goes into the buffer region, the wire is folded for several times and then is twisted and rolled for several turns to make the wire thicker. Next, the thicker wire is wound around the iron core in the buffer region for several turns and then the thicker wire passes the intermediate area and goes into the right-most winding partition.

### BACKGROUND OF THE INVENTION

1. Field of the invention

The invention generally relates to an improved transformer. More particularly, the invention relates to an improved transformer, in which a buffer region is used to hold the division point of the thicker wire to avoid breakages of the wire and to improve the quality and stability of the transformer.

2. Description of the Prior Art

The coil type transformer has been around for more than 100 years. Many improvements and modifications have been made to improve the coil type transformer. Despite these improvements and modifications, the coil type transformer operates according to the same physical principle, mutual induction.

In the coil type transformer, mutual induction occurs if an emf is induced in a coil because of current changes in a second coil. A primary coil and the secondary coil are wound around the same iron core. The primary coil is connected to the source of electrical energy and the secondary coil is connected to a load. When ac is applied to the primary coil, changes in magnetic flux would occur in the iron core and the changes would cause an ac with the same frequency in the secondary coil. The ratio of primary voltage (or emf) to secondary voltage (or emf) is in proportional to the ratio of the number of turns on the primary coil to the number of turns on the secondary coil. Therefore, if the number of turns on the secondary coil is more than the number of turns on the primary coil, the output voltage is greater than the input voltage and it is called a step-up transformer; conversely, if the number of turns on the secondary coil is less than the number of turns on the primary coil, the output voltage is less than the input voltage and it is called a step-down transformer.

Therefore, coils are the most important parts of the coil type transformer. In addition to the quality of the wires, how winding is done is quiet important. Especially, in small-size step-down transformer, a very fine wire is usually used for the winding; therefore, the wire is prone to breakages (which may lead to a short circuit) and damages if the winding is not done meticulously.

Please refer to FIG. 8, which illustrates the structure of a coil type transformer of the prior art. The transformer has a main body 4 and the main body 4 has several winding partitions 41. The winding partitions 41 can facilitate the winding of the wire 5. One end of the wire 5 is connected to a lead 42.

With regard to the secondary coil, the wire 5 is folded for several times and is twisted and rolled for several turns to make the wire 5 thicker (to make it stronger) and then the thicker wire 6 is wound around the core.

A division point, which divides the wire 5 from the thicker wire 6, would be formed. Such division point is prone to breakage. Therefore, winding must be carried out with extra care to avoid such breakage and hence the efficiency of production is impeded.

In addition, the wire 5 and the thicker wire 6 have different thicknesses. This would affect the precision of winding and thus quality of the transformer would suffer. Moreover, imprecise winding would produce error in the resultant voltage and may even cause damage to the transformer.

From the above, we can see that the transformer of the prior art has many disadvantages and drawbacks and needs to be improved.

To eliminate the disadvantages of the transformer of the prior art, the inventor has put a lot of effort into the subject and has successfully come up with the improved transformer of the present invention.

### SUMMARY OF THE INVENTION

An object of the present invention is to provide an improved transformer that has a buffer region so that the division point may be held in the buffer region. Therefore, quality and stability may be improved.

Another object of the present invention is to provide an improved transformer in which the thicker wire and division point are held in the buffer region so that the winding is not prone to breakages and damages. Moreover, thanks to the buffer region, troubleshooting and repair may be done easily and quickly.

To reach these objects, the improved transformer of the present invention is disclosed. The improved transformer of the present invention comprises a main body and a wire. The main body has several winding partitions and two end portions. Several leads are disposed in either end portion and a buffer region is formed between the right end portion and the right-most winding partition. An intermediate area is disposed between the buffer region and the right-most winding partition. One end of the wire is connected to one of the leads and the wire passes the right end portion. Before the wire goes into the buffer region, the wire is folded for several times and then is twisted and rolled for several turns to make the wire thicker. Next, the thicker wire is wound around the core in the buffer region for several turns and then the thicker wire passes the intermediate area and goes into the right-most winding partition. In the right-most winding partition and other winding partitions, winding may be carried out swiftly and precisely. A key point of the improved transformer of the present invention is the use of the buffer region because it can hold the division point of the thicker wire. Because the buffer region is independent of the functions of the transformer, the winding in the buffer region dies not need to be neat and precise.

### BRIEF DESCRIPTION OF THE DRAWINGS

FIG. 1 is a perspective view illustrating the main body of the improved transformer of the present invention.

FIG. 2 is another perspective view illustrating the main body of the improved transformer of the present invention.

FIG. 3 is a third perspective view illustrating the main body of the improved transformer of the present invention.

FIG. 4 is a top view illustrating the main body of the improved transformer of the present invention.

FIG. 5 is a bottom view illustrating how the wire is wound around the iron core in the main body.

FIG. 6 is a view illustrating how the wire is folded for several times.

FIG. 7 is a view illustrating the wire is made thicker after it is folded for several times and is twisted and rolled for several turns.

FIG. 8 is a bottom view illustrating how the wire is wound around an iron core in a main body in the prior art.

### DETAILED DESCRIPTION OF THE PREFERRED EMBODIMENT

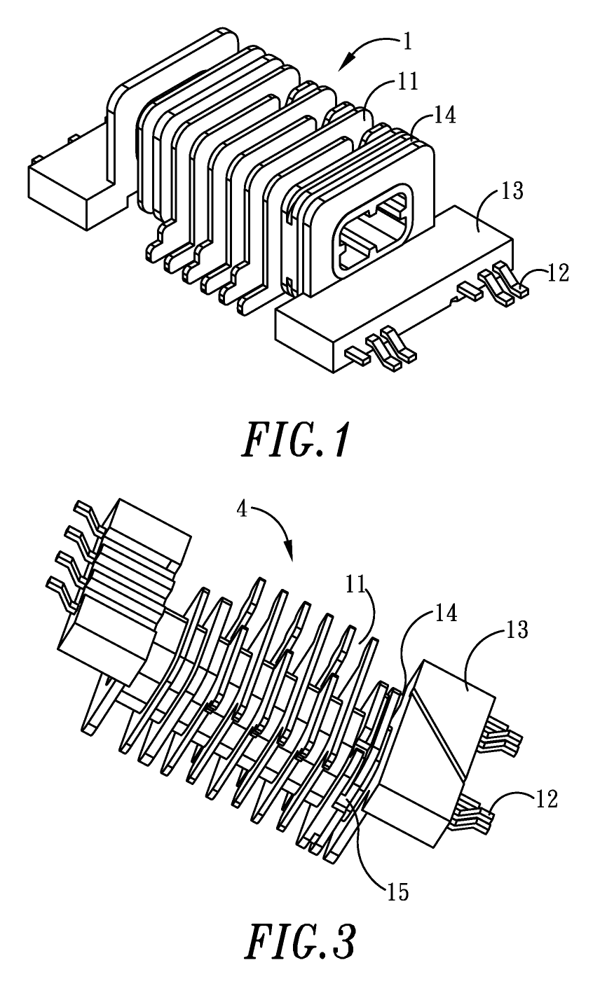

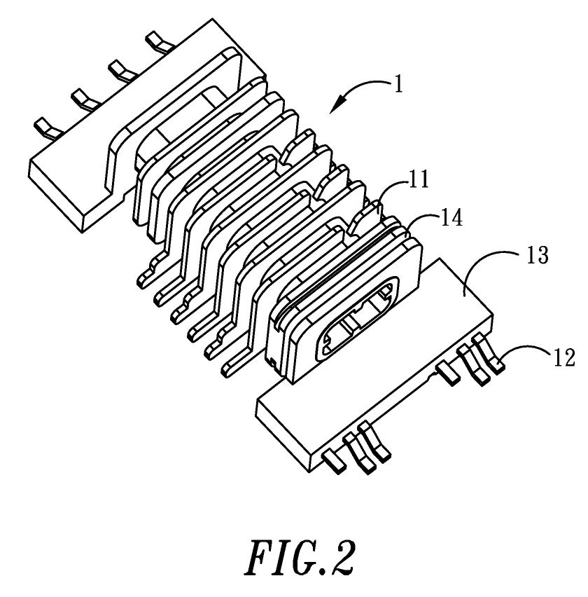

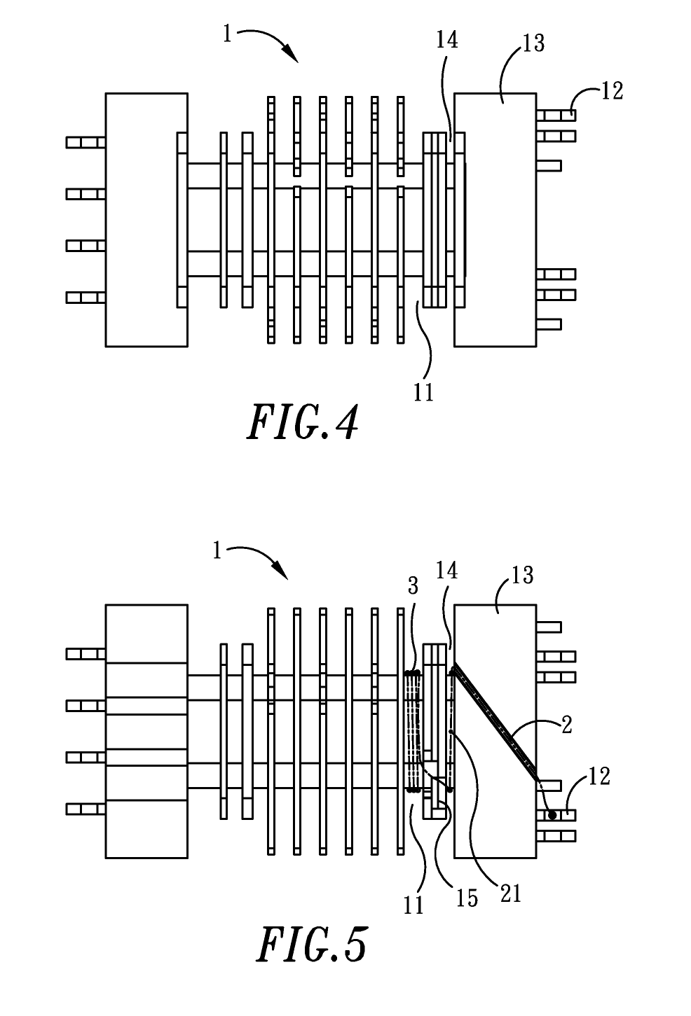

Please refer to FIGS. 1 to 5, which illustrate the improved transformer of the present invention. The improved transformer of the present invention comprises a main body 1 and a wire 2. The main body 1 has several winding partitions 11 and two end portions 13. Several leads 12 are disposed in either end portion 13. A buffer region 14 is formed between the right end portion 13 and the right-most winding partition 11. An intermediate area 15 is disposed between the buffer region 14 and the right-most winding partition 11. One end of the wire 2 is connected to one of the leads 12. The wire passes the right end portion 13. Before the wire 2 goes into the buffer region 14, the wire 2 is folded for several times and then is twisted and rolled for several turns to make the wire thicker. Then the thicker wire 3 is wound around the core in the buffer region 14 for several turns. Then, the thicker wire 3 passes the intermediate area 15 and goes into the winding partition 11. Next, the thicker wire 3 is wound around the core in the winding partition 11.

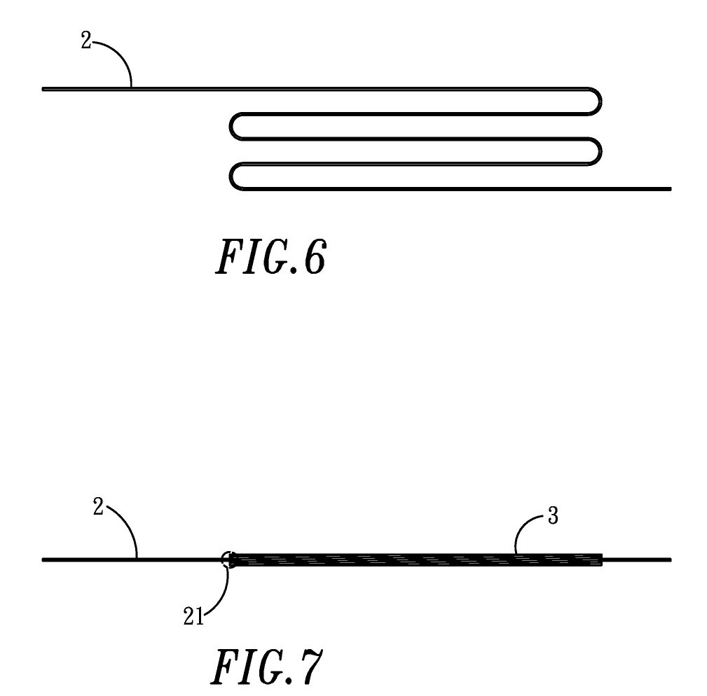

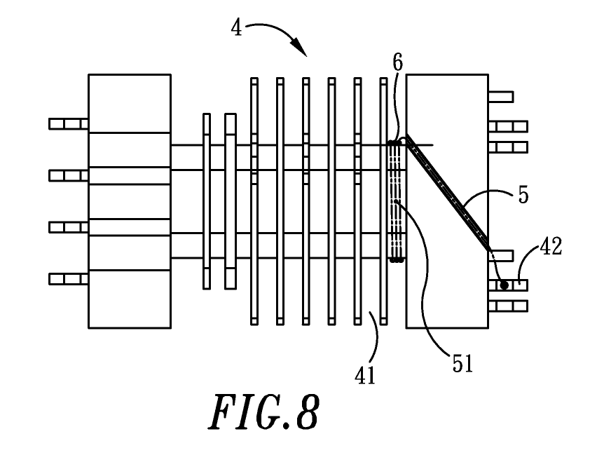

Now, please refer to FIGS. 6 and 7. Because the wire 2 is too thin, the wire 2 is subject to bending or breakage if it is wound around the core in the winding partition 11. Therefore, the wire 2 is folded for several times and then is twisted and rolled for several turns to make the wire 2 thicker. Now, the thicker wire 3 may be obtained.

A division point 21 would be formed between the wire 2 and the thicker wire 3. The division point 21 is subject to breakage if it is wound around the iron core in the winding partition 11. Such breakage would lead to malfunction or short circuit. Therefore, the segment of the wire 2 and 3 containing the division point 21 is wound around the core in the buffer region 14 for several turns (because the buffer region 14 is independent of the functions of the transformer, the winding in the buffer region 14 dies not need to be neat and precise) and is then wound around the iron core in the winding partition 11. In addition, to avoid the bending and damage of the wire 2 when it goes from the buffer region 14 to the right-most winding partition 11, the intermediate area 15 can guide the wire 2. Therefore, the intermediate area 15 can better the transformer.

In comparison to the prior art, the improved transformer of the present invention has the following advantages:
1. The improved transformer of the present invention has a higher quality and a longer service life because the windings are not prone to breakages and damages and the errors in the resultant voltage may be avoided.
2. In the improved transformer of the present invention, the wire is wound around the iron core in several well-defined segments; therefore, troubleshooting and repair may be done easily and quickly.

Although a preferred embodiment of the present invention has been described in detail hereinabove, it should be understood that the preferred embodiment is to be regarded in an illustrative manner rather than a restrictive manner, and all variations and modifications of the basic inventive concepts herein taught still fall within the scope of the present invention.

What is claimed is:

1. A transformer, comprising:
a main body, having several winding partitions and two end portions, wherein several leads are disposed in either end portion and a buffer region is formed between a right end portion and a right-most winding partition; and
a wire, wherein one end of the wire is connected to one of the leads and the wire passes the right end portion and the wire is folded for several times and then is twisted and rolled for several turns to make the wire thicker before the wire goes into the buffer region, characterized in that the thicker wire is wound around a iron core in the buffer region for several turns and then the thicker wire goes into the right-most winding partition.

2. The transformer as in claim 1, wherein an intermediate area is disposed between the buffer region and the right-most winding partition to guide the thicker wire from the buffer region to the right-most winding partition.
